(19) United States
(12) Patent Application Publication
(10) Pub. No.: US 2013/0024494 A1
(43) Pub. Date: Jan. 24, 2013

(54) METHODS AND SYSTEMS FOR PLATFORM OPTIMIZED DESIGN

(71) Applicant: Steven Guarrieri, Plymouth Meeting, PA (US)

(72) Inventor: Steven Guarrieri, Plymouth Meeting, PA (US)

(21) Appl. No.: 13/158,571

(22) Filed: Jun. 13, 2011

(51) Int. Cl. G06F 15/16

(52) U.S. Cl. 709/203

(57) ABSTRACT

Embodiments of the disclosed invention include a plurality of preconfigured hardware platforms. The plurality of preconfigured hardware platforms includes a set of preconfigured server hardware platforms, a set of preconfigured network hardware platforms, and a set of preconfigured storage hardware platforms. At least one preconfigured server hardware platform, at least one preconfigured network hardware platform, and at least one preconfigured storage hardware platform that when combined forms a combination that balances a computing request rate, a network request rate, and a storage request rate for one of a web tier, an application tier, and a data tier system.

### FIELD OF THE INVENTION

Embodiments of the present invention generally relate to a system and method for balancing, deploying, and managing a cloud computing environment. More specifically, embodiments of the invention provide aim to simplify, speed deployment, and optimize utilization of resources as well as drive interoperability of the three core datacenter components: servers, storage and network.

### BACKGROUND

Three decades ago, capacity planning was handled by a team of experts who lovingly cared for a single mainframe. To justify the cost of a mainframe, every effort was made to wring out every CPU cycle. The complex and error-prone process included monitoring workloads, assessing business growth and requirements and correctly predicting when the mainframe should be upgraded. Upgrading too soon translated into excess costs due to the premium for cutting-edge technology, disturbance to the environment, downtime, and the expense of under-utilizing the costly server resources. Eventually, workloads disintegrated into multiple asynchronous workloads that could execute on multiple servers, including less expensive, commodity servers. The team was then faced with speeding up the capacity planning process so that servers could be monitored, analyzed, modeled and managed for capacity.

With the commoditization of server virtualization, another wave of disintegration has occurred. The number of virtual servers to be managed can be one or two orders of magnitude more than the physical servers that were being managed 5 years ago. In particular, with the advent of cloud computing, traditional management processes could no longer easily scale up where large numbers of servers are needed to “feed” a growing cloud within seconds. For instance, when planning to deploy a cloud computing environment, there are some unusual wrinkles in the standard approach for capacity planning. For example, the cloud allows users to provision their own resources (servers/storage/networks). Successful clouds keep up with demand in a way to present a façade of infinite elasticity. Cloud providers do not have control over what workloads will be using the cloud. Therefore, traditional approaches to capacity planning based on careful measurements of workloads and their forecasted growth, cannot anticipate capacity in a timely manner in a cloud computing environment.

Accordingly, the disclosed embodiments provide a pragmatic approach to cloud computing aimed to simplify, speed deployment, and optimize utilization of resources in a cloud computing environment.

### SUMMARY

The disclosed embodiments include a method, apparatus, and computer program product for managing resources such as servers of a cloud service provider. For instance, in one example, system comprises a plurality of preconfigured hardware platforms that when combined is operable to reach maximum utilization of a computing request rate, a network request rate, and a storage request rate at approximately the same time.

As another embodiment, a system comprises a server hardware platform; a network hardware platform; and a storage hardware platform, wherein the server hardware platform, the network hardware platform, and the storage hardware platform are preconfigured based upon a workload profile for one of a plurality of tiers.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The accompanying drawings constitute a part of this specification and illustrate one or more embodiments of the disclosed system and methods, and further enhance the description thereof provided in this specification.

FIG. 1 illustrates a network environment in which certain illustrative embodiments may be implemented;

FIG. 2 illustrates a system in which certain illustrative embodiments may be implemented;

FIG. 3 illustrates a process for generating a profile in accordance with an exemplary embodiment;

FIG. 4 illustrates a profile generated for a web tier in accordance with an exemplary embodiment;

FIG. 5 illustrates a profile generated for an application tier in accordance with an exemplary embodiment;

FIG. 6 illustrates a profile generated for a data storage tier in accordance with an exemplary embodiment;

FIG. 7 illustrates a Medium Platform Optimized Design (POD) for virtualized web tier configurations in accordance with an exemplary embodiment;

FIG. 8 illustrates a Large Platform Optimized Design (POD) for virtualized application tier configurations in accordance with an exemplary embodiment;

FIG. 9 illustrates an Enterprise Scalable (ESC) POD configuration in accordance with an exemplary embodiment; and

FIG. 10 illustrates a small SAN and NFS high availability storage POD configuration in accordance with an exemplary embodiment.

### DETAILED DESCRIPTION

The disclosed embodiments and advantages thereof are best understood by referring to FIGS. 1-10 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

Cloud computing, as referenced herein, refers to the provision of computational resources via a computer network. Cloud computing is an approach that enables organizations to leverage scalable, elastic and secure resources as services with the expected results of simplified operations, significant savings in cost and nearly instant provisioning. Some of the key tenets associated with cloud are elasticity and scalability, where resources can expand and contract as needed, and “Anything as a Service” (XaaS), where the details and concerns of implementation are abstracted for the customer.

Beginning with FIG. 1, a cloud computing environment 100 in which certain illustrative embodiments may be implemented is depicted. The cloud computing environment 100 includes a plurality of client devices 102 that communicate over a network 110 with one or more systems of a cloud service provider 120. The network 110 may be any type of network including a wide area network, a local area network, a wireless network, one or more private networks, and the Internet. The client devices 102 may be any type of electronic device including, but not limited to, a laptop, personal computer, mobile phone, tablet, and personal digital assistant (PDA). The cloud service provider 120 provides computing resources, application services, and data storage to the plurality of client devices 102 using a plurality of servers. The plurality of servers may be located in one or more datacenters associated with the cloud service provider 120. The plurality of servers includes three main tiers/types of servers, a web tier 132, an application tier 134, and a data tier 136.

In support of the cloud computing principles, the disclosed embodiments recognize that the datacenter is undergoing a transformation driven by a “perfect storm” that is comprised of technology advances, extreme automation, and business shifts due to economic challenges. A major factor in this transformation is extreme automation and sense-and-respond systems that enable users to provision and migrate virtual machines (VMs) in minutes. Automation software centers on policy management of workload demand. Service monitoring focuses on optimizing the supply of resources for workloads. This optimization includes end-to-end transaction monitoring, environmental monitoring, resource correlation, performance and consumption monitoring.

Another contributor in this storm is a business shift that is driven by economic challenges and the need for agility. This business shift is movement toward Service Oriented Architecture (SOA), which is a methodology supported by data center transformation and embraced by cloud computing. SOA includes service governance, which leads to aligning current to future state. It leverages existing applications, provides for business value chain (BVC) alignment and enables future state planning. An SOA service infrastructure focuses on optimizing the supply of resources for workloads.

The disclosed embodiments recognize that transforming the datacenter requires new thinking regarding infrastructure economics as well as capacity planning and sizing. Current processes are relatively static and rigid, which makes planning and implementing them slow and ponderous. Workload patterns for the web-, application- and database tiers can be characterized by the ratio of compute, network and storage capacity and utilization. The disclosed embodiments recognize that providing simplified architecture that provides at least a minimal amount of performance and maintains the workload patterns while scaling for additional capacity would appeal to both datacenter architects and end users alike. Simplified architecture leads to simplified operations and significant savings as well as leading to greater elasticity and scalability.

Accordingly, the disclosed embodiments provide a methodology and a set of reference architectures, which integrate building blocks, referred to as Platform Optimized Designs (PODs). The methodology aims to simplify, speed deployment, and optimize utilization of resources as well as drive interoperability of the three core data center components: servers, storage and network. A reference architecture, which includes the alignment and characterization of general data center workloads, supports a building block methodology that is both agile and scalable and necessary to meet the demands of the enterprise data center.

The following disclosure will describe the attributes of server and storage PODs that have been developed to create balanced systems among the three main tiers that form the pattern for today's applications—the web tier 132, the application tier 134, and the data tier 136. The notion of “balanced systems” arises where the system is properly balanced to handle the workload demands. In a perfectly balanced system, when the system reaches the maximum number of CPU arrival requests that the system can sustain, the system will also reach the maximum request rate for storage and networks. Additionally, a balanced system provides infrastructure capabilities to meet workload demands with adherence to the relative measures of compute, network and storage capacity

In contrast to a balanced system, if a workload predominately demands network resources, with little CPU or storage activity, then hosting that workload on a system that is configured for processor-intensive High Performance Computing (HPC) will waste CPU and memory resources and perhaps not keep up with the demands for network resources. If the system is not properly balanced, then, as more systems are added to address capacity, the costly underuse of CPU resources is compounded while the real bottleneck continues to plague the cloud provider.

The disclosed PODs provide building blocks that are independently scalable and therefore, deliver significantly greater ‘efficiency’ than alternate industry solutions. The PODS can be augmented with technologies to address specific customer requirements and Service Level Agreements (SLA) including availability and Quality of Service (QoS). In order to match the workload of an enterprise to these PODs, the disclosed embodiments explore and analyze compute-to-I/O ratios and workload characteristics that are common to each of these tiers to generate a profile for each tier.

The workload is the load that executes on the infrastructure based on business activity. For example, requirements for a SAP-based application development environment might include business activity as defined by SAP transactions/sec and resource requirements as defined by CPU utilization, storage requests and network traffic. Quality requirements include service level requirements such as availability (for example, 99.99%) or quality of service (for example, response time). Meeting such requirements depends on the Reliability, Accessibility, and Scalability (RAS) characteristics of the underlying POD architecture and associated software.

The infrastructure of the reference configuration includes hardware plus operating system and virtualization software that are aligned with specific types of workloads. The infrastructure includes network support for the management subsystem but does not specify server or storage components required exclusively for management. For example, capabilities might include the compute capacity as determined by the number and type of VMs, transactions (of a specified workload) per second, I/O capacity in terms of I/O bandwidth, IOPS, storage and network bandwidth and latencies. Additional capabilities might include load balancing, fault tolerance or the functionality required by the customer (for example, server virtualization, support for .Net/Java and so on).

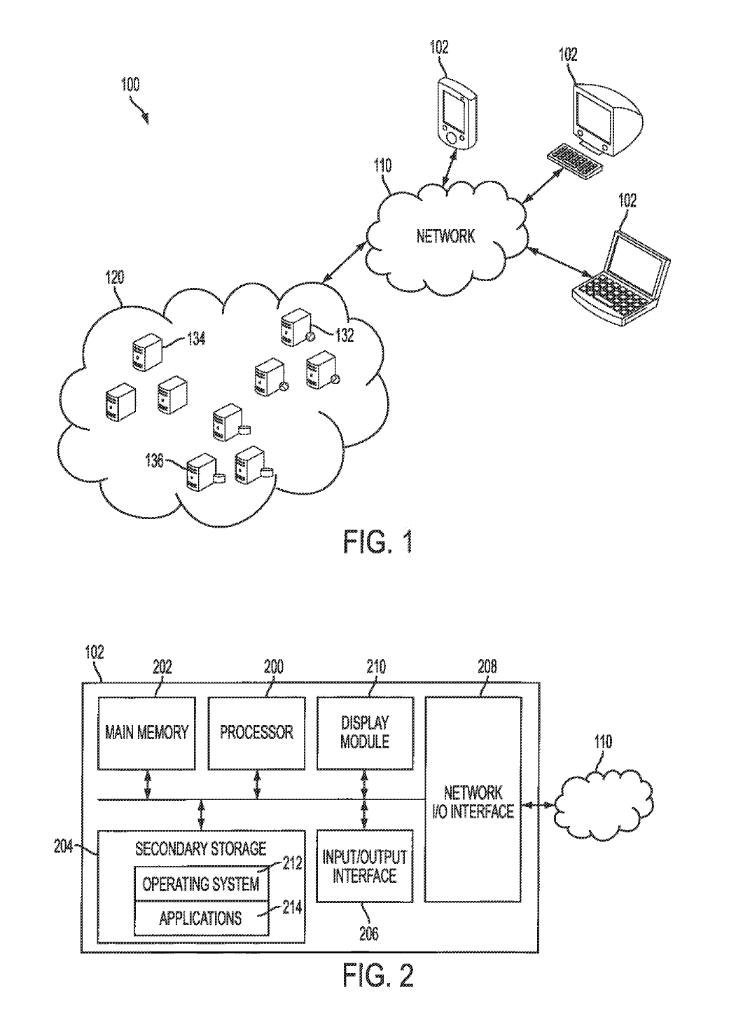

FIG. 2 depicts a schematic diagram illustrating the basic components of an example architecture of a system 200 in which embodiments of the may be implemented. The system 200 includes a processor 200, main memory 202, secondary storage unit 204, and a communication interface module 208 for enabling the system 200 to communicate with the network 110. The processor 200 may be any type of processor capable of executing instructions for performing functions associated with the system 200 and the features associated with the claimed embodiments.

Main memory 202 is volatile memory that stores currently executing instructions/data, or instructions/data that are prefetched for execution.

The secondary storage unit 204 is non-volatile memory for storing persistent data (e.g., a hard drive). The secondary storage unit 204 stores the instructions associated with an operating system 212. The operating system 212 is software, consisting of programs and data, which manages the hardware resources of the system 200 and provides common services for execution of various applications 214.

In some embodiments, the system 200 may include an input/output interface module 206 that enables the system 200 to receive user input and to output information to a user or other devices. For example, the input/output interface module 206 may include a keyboard interface for receiving keyboard inputs from a user. The input/output interface module 206 may also enable external devices to be connected to the system 200.

In addition, in some embodiments, the system 200 may include a display module 210 such as a graphics card that enables information to be displayed on an internal or external display device.

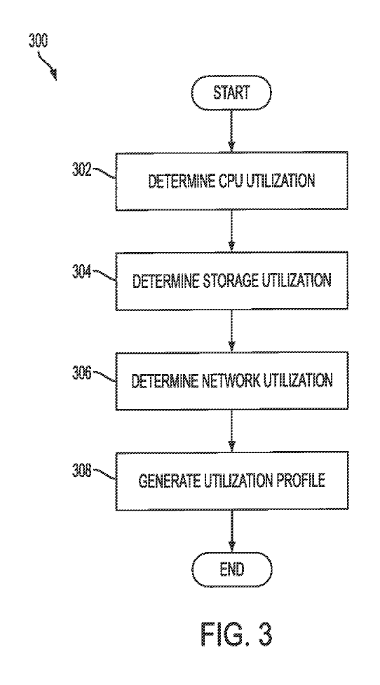

FIG. 3 depicts a flowchart describing a process 300 for generating a profile for each of the three main tiers (the web tier 132, the application tier 134, and the data tier 136). One of ordinary skill in the art will recognize that the process 300 may be written using any type of programming language and converted to machine readable instructions. These instructions may be stored in the secondary storage unit 204 and/or main memory 202 and executed by the processor 200 of the system 200. For example, in one embodiment, process 300 may be implemented directly on one or more systems in each of the three main tiers. In an alternative embodiment, process 300 may be implemented on a third party system that is configured to monitor the performance of one or more systems in each of the three main tiers.

At step 302, the process 300 determines CPU utilization for a particular machine. In one embodiment, the process retrieves CPU percent utilization from the statistics that are gathered by the operating system of the particular machine. To illustrate this, if CPU percent utilization is measured to be 75%, this means that, for each elapsed second, the CPU was busy for 0.75 of the second. The standard notation for utilization is ρ, which is a number between 0 and 1. Therefore, CPU activity per second is denoted as ρ_{CPU}, where ρ_{CPU}=(% Processor Time)/100.

At steps 304 and 306, the process 300 similarly determines storage and network utilization. Again, in one embodiment, the process 300 the process determines storage and network utilization from the statistics that are gathered by the operating system of the particular machine. From the operating system's point of view, storage I/O utilization can be directly measured for each physical disk. Utilizing the % Idle Time gathered from the operating system, and following equation may be utilized to determine storage I/O utilization.

$${\sum }_{i = 1}^{n} \text{?} = Sum of ( 100 - \% Idle Time ) / 100$$

$$\text{?} \text{indicates text missing or illegible when filed}$$

for all instances, for i=1 . . . n disks

It should be noted that the term physical disk includes storage subsystems that may be shared by multiple servers. This is possible through virtual storage subsystems or Storage Area Networks (SANs). For network devices, the operating system does not measure any delay because, from its vantage point, packets going in and out of the server will be transferred at the current bandwidth of the network interface device. So, although the operating system is reporting what it sees as classical disk utilization, the values may be skewed due to queuing by other servers in the back end subsystem.

For network activity, the process can measure the individual components of the equation using the Network Interface group of counters. For each network interface, measure Bytes Total/s and use the maximum bandwidth, as indicated by the network interface vendor.

$${\sum }_{j = 1}^{m} ρ {N}_{j} = Sum$$

of (Bytes Total/sec/(Network Interface Bandwidth (bytes/sec)) for all instances for j=1 . . . m network interfaces

Although the above example utilizes statistics gathered from the operating system, in an alternative embodiment, third party software may be used gather the statistics necessary to determine the above performance parameters.

Based on the gathered statistics, the relationship between the CPU utilization, data storage utilization, and network utilization can be express as the following tuple:

$$( {ρ}_{CPU} , \frac{\text{?}}{n} , \frac{\text{?}}{m} )$$

$$\text{?} \text{indicates text missing or illegible when filed}$$

Where:

ρ_{CPU} is the utilization of CPU on a server;

$$\frac{{\sum }_{i = 1}^{n} \text{?}}{n}$$

$$\text{?} \text{indicates text missing or illegible when filed}$$

is the average utilization of all storage devices attached to the server; and

$$\frac{{\sum }_{j = 1}^{m} \text{?}}{m}$$

$$\text{?} \text{indicates text missing or illegible when filed}$$

is the average utilization of all network devices attached to the server.

Based on the gathered statistics, at step 308, the process generates a profile regarding the workload activity with the particular machine, with process 300 terminating thereafter.

Based on the profiles generated for each of the machines, a specific tier profile regarding the workload activity for each of the three main system tiers (web tier 132, application tier 134, and data tier 136) may be constructed. Although it is acknowledged that exceptions exist, at a base level, each of these tiers require a different balance of resources at the system level.

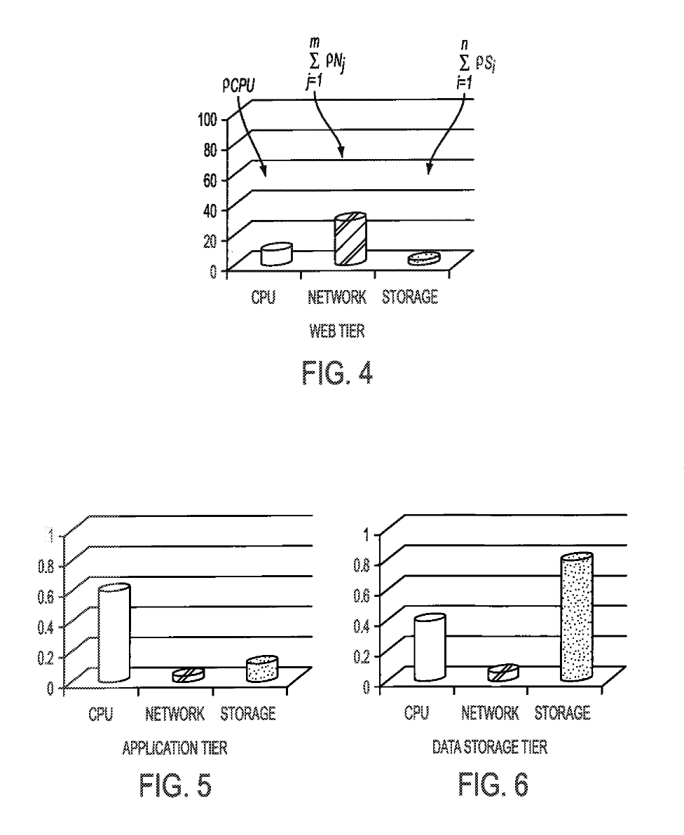

For example, FIG. 4 illustrates an exemplary profile generated for the web tier systems. As can be seen, the web tier systems have low CPU and memory utilization; low disk capacity with low storage I/Os per second (IOPS) requirements. This environment requires that moderate-to-high network bandwidth be specified in both packets per second and MB per second. In this type of environment, the memory usage might scale linearly with the CPU utilization.

FIG. 5 illustrates an exemplary profile generated for the application tier systems. The application tier profile shows moderate CPU and memory utilization; moderate disk capacity with moderate-to high storage and network IOPS requirements (depending on application and use case). This environment requires high network bandwidth both in packets per second and MB per second. The application tier has far less network activity than the web tier and more CPU activity, with more storage activity.

FIG. 6 illustrates an exemplary profile generated for the database tier systems. The database tier has high CPU and memory utilization and requirements. This environment requires high disk capacity with high IOPS along with moderate-to high network bandwidth both in packets per second and MB per second. Requirements in this environment increase with the transaction workload; performance also depends on application and use case. Disk IOPS depend on read/write ratios and the layout of the database.

In each of the graphs of FIGS. 4-6, it is visually obvious that the three utilizations will not reach 100% utilization at the same time. Therefore, the current resources for the systems in each of these tiers are unbalanced because one of the resources will be exhausted before the others.

Of course, the above profiles for each of the tiers may change based on technological advances. For example, what if the CPU technologies differ so that the target servers can execute 25% more CPU cycles? Or what if network interfaces with 10 times the bandwidth are used? For storage utilization, what if spinning disks are replaced by solid state disk?

Therefore, in an alternative embodiment, the above approach may be slightly modified so that it is hardware independent. In other words, determining the workload demand irrespective of the target hardware. In order to do so, we modify the above statistics to requests per second and not the time per request. For instance, we defined:

λ_{*}=Arrival rate for resource*

E[s]_{*}=Average service time per request for resource*

Then, the utilization of a resource such as CPU can be expressed as:

ρ_{CPU}=λ_{CPU}E[s]_{CPU}

We can then re-write the above tuple as:

$$( {λ}_{CPU} \text{?} , \frac{\text{?}}{n} , \frac{\text{?}}{m} )$$

$$\text{?} \text{indicates text missing or illegible when filed}$$

Within the Physical Disk group, we can determine the arrival rate for each logical disk for i=1 . . . n disks as:

$$\text{?} = Disk Transfers \text{/} Sec$$

$$\text{?} = \frac{( 100 \text{?} \% Idle Time )}{\text{?}}$$

$$\text{?} \text{indicates text missing or illegible when filed}$$

Within the Network Interface group, we can determine the arrival rate for each network interface for j=1 . . . m network interfaces as:

λ_{N}_{ⱼ}=Packets/Sec

E[s]_{N}_{ⱼ}=(Bytes Total/sec/(Network Interface Bandwidth (bytes/sec))/λ_{N}_{ⱼ}

In accordance with the disclosed embodiments, a system is considered balanced when the maximum number of CPU arrival requests that the system can sustain and the maximum request rate for storage and networks are reached at approximately the same time. Therefore, the relationship between

$${λ}_{CPU} , {\sum }_{i = 1}^{n} \text{?} , and {\sum }_{j = 1}^{m} \text{?}$$

$$\text{?} \text{indicates text missing or illegible when filed}$$

must be determined in order to balance the system for each of the three profiles.

Using the above process, the disclosed embodiments provide a rough/“good enough” infrastructure that aims to balance infrastructure capabilities and cost with workload requirements using standard building blocks (PODs) plus additional components to form Reference Architectures (RAs) and matches the customer workload requirements to the Infrastructure capabilities.

As referenced herein, a Solution Architecture (SA) is a collection of technical capabilities that provides business value. An SA serves as an architectural construct that identifies the technologies needed to support a specific project and identifies similar projects that have already been deployed in the environment. Additionally, an SA provides a baseline for immediately creating and deploying an infrastructure solution that meets a specific business need.

The disclosed embodiments provide a ‘simpler’ approach to capacity planning that helps clarify the proposed direction for the infrastructure and accelerates deployment as compared to the traditional approach that is based on careful measurements of workloads and their forecasted growth. In addition to accelerating deployment, the disclosed approach is easier to modify in response to a change in the workload, whereas the traditional approach cannot anticipate capacity changes in a timely manner. Therefore, the disclosed embodiments reduce cost and complexity associated with managing the datacenter.

In addition, the disclosed embodiments are easily scalable to newer technology. For instance, during a datacenter transformation, older infrastructure may be replaced with newer components. This can ultimately save on capital and operational expenses, as well as reducing power and cooling costs. For example, the disclosed embodiments may be easily scaled by establishing a change factor based on an estimation of a new CPU utilization against the current utilization. The change factor may be based on an industry standard benchmark, such as, but not limited to, benchmarks provided by SPECint. SPECint is a computer benchmark specification to determine a CPU's integer processing power and it is maintained by the Standard Performance Evaluation Corporation (SPEC). As an example, representing the SpecInt results for Server X and Server Y as a_{X} and a_{Y} and the average service time per request for Server X is E[s]_{CPU}_{_{X}} then we can estimate the CPU time on the target (Server Y) as:

E[s]_{CPU}_{_{Y}}=a_{Y}^{a}^{_{X}}E[s]_{CPU}_{_{X}}

For example, assume Server X benchmark indicates a base value of 100 and Server Y's benchmark indicates 125. Since the SpecInt value increases as an inverse to the CPU service times, a server that is 25% faster according to the benchmark will yield:

a_{Y}^{a}^{_{X}}=0.80

Conversely, the number of CPU requests that can be sustained on a fully utilized system is 25% higher than Server X. Therefore, in order to maintain the same balance, the system of the disclosed embodiments need to also scale the system resources to support 25% more requests for network and storage resources.

As shown above, the disclosed embodiments provide an approach to deal with the uncertainties of the cloud-based workloads by suggesting a small number of profiles based on the current pattern of web, application and database tiers. The methodology supports an agile deployment model that is used early in the service delivery model and does not preclude the use of deeper forensics and analysis. The disclosed embodiments enable quick deployment and expansion of resources as is necessary in a cloud computing environment to provide the façade of infinite elasticity. As the cloud expands, additional infrastructure can be quickly deployed so that it is balanced to handle the profiles without over-configuring in the areas of CPU, storage and networking resources.

To further expedite deployment, the disclosed embodiments recommend that the Reference Architecture (RA) be the lowest granularity of a deliverable product. The RA contains any combination of components, frameworks and services including third party products that are necessary to address specific customer requirements. RAs might contain a single component or POD; however, they usually contain more than one. Although the RAs may include optional components and reference configurations (such as, special I/O adapters, switch/firewall, and so on that might require services to validate), the goal is to encourage the solution-centric model. In this embodiment, only RAs are released and supported; and components are not optional within a solution. The components defined for the PODs or components in the aggregation layer relative to a solution might be replaced, added, or removed over time.

The disclosed embodiments define server (compute), network and storage PODs independently in order to balance the infrastructure capabilities and the workload requirements associated with the primary data-center tiers: the web tier 132, the application tier 134, and the data tier 136.

In one embodiment, the tier models are derived under the assumption that these environments could be and should be 100 percent virtualized in a secure, multitenant configuration. As such, priorities include VM density, I/O flexibility and an efficient yet resilient power and cooling solution. The reference configurations for the tier models target a single rack mounted cabinet design. That is, the compute, network and storage capacity for the base infrastructure is achievable within a standard rack.

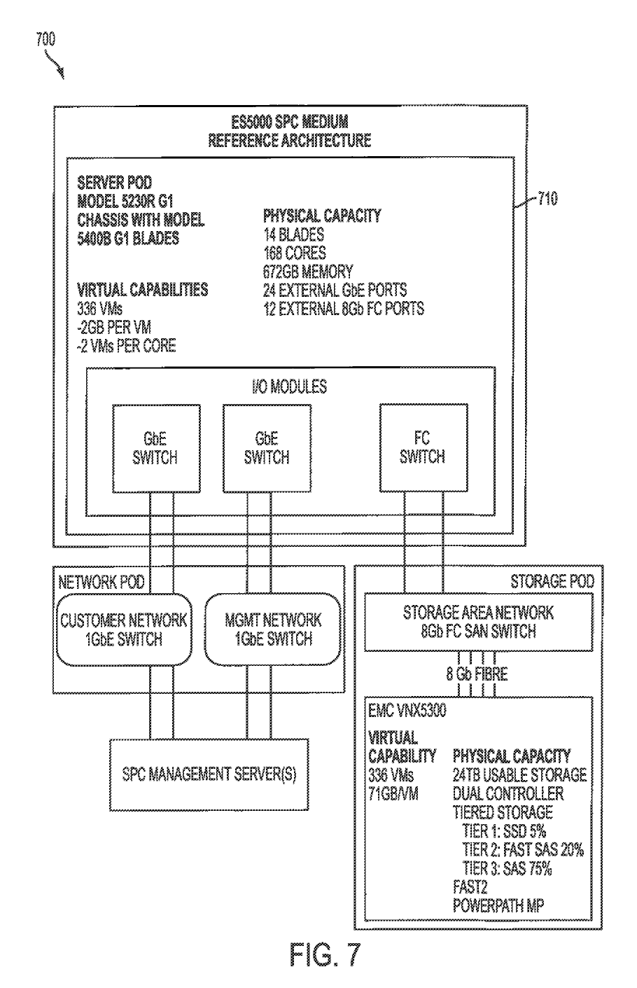

For example, with reference now to FIG. 7, an embodiment of a medium POD for virtualized web tier configurations 700 is presented, which targets application workloads that can leverage high-density, scale-out architecture. The medium POD configuration 700 supports VMs that require relatively lower CPU/memory resource utilization as well as resilience for the web tier. The configuration for the medium POD configuration includes a blade chassis 710, which supports a maximum capacity of 14 blades with a total of 168 cores and 672 GB of memory (supporting 336 VMs, each with 2 GB of memory per VM and 2 VMs per core).

In the disclosed embodiment, two different types of storage options are available—FC SAN or iSCSI storage arrays. The storage capacity is sized accordingly with the maximum VMs. For instance, 336 VMs*30 GB of storage per VM yields 10.08 TB of usable capacity. The configured raw capacity addresses operating system formatting and RAID considerations.

The medium POD configuration 700 optimizes network performance and includes multiple virtualization solutions. In one embodiment, the medium POD configuration 700 includes a VMware ESX hypervisor—vSphere 4 Enterprise Plus, vCenter for VM management (hosted on SPC management server) and vShield for secure zoning. In a VMware high availability (HA) environment, the usable configuration is 156 cores and 624 GB of memory (supporting 312 VMs each with 2 GB of memory per VM and 2 VMs per core).

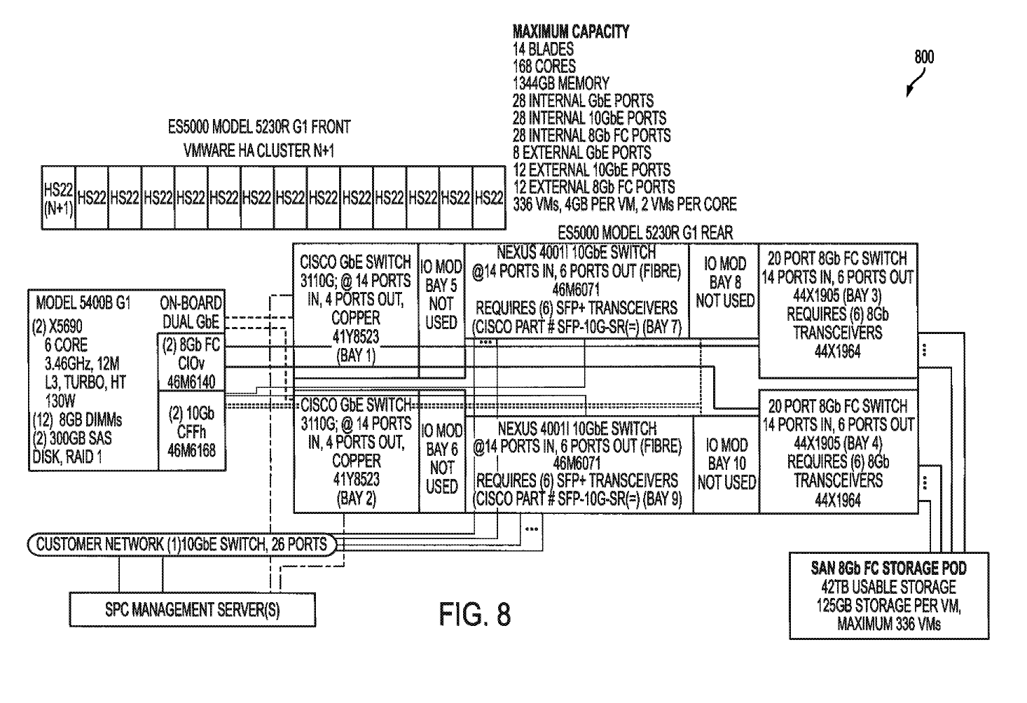

FIG. 8 illustrates an embodiment of a Large POD for virtualized high performance configurations 800, which target application workloads that can leverage high density scale-out architecture. The large POD configuration 800 hosts large memory/storage VMs and is a good general purpose system that is best suited for the application tier 134. The large POD configuration 800 includes a blade chassis that supports a maximum capacity of 168 cores and 1344 GB of memory (supporting 336 VMs, each with 4 GB of memory per VM and 2 VMs per core). In certain embodiments, the large POD configuration 800 supports different storage options that provide a maximum of 50 TB of raw storage.

In the VMware HA environment, the usable configuration consists of 156 cores and 1248 GB of memory (supporting 312 VMs, each with 4 GB of memory per VM and 2 VMs per core). This configuration optimizes processing, network and storage performance utilizing 10-Gb Ethernet connections and 8-Gb storage connections. In one embodiment, the large POD configuration 800 includes a connection to storage area network (SAN) storage having 42 TB of usable storage. Alternatively, the large POD configuration 800 could include a connection to Network-attached storage (NAS) storage.

In one embodiment, the software configuration of the large POD 800 configuration includes VMware ESX™, vSphere™, vCenter™ and vShield™. vSphere™ is a cloud operating system that is able to manage large pools of virtualized computing infrastructure. The large POD configuration 800 may be paired with multiple storage options including RAID, HA configurations with redundant SAN switches with load balancing, and finally, fully automated DRS and vSphere clusters.

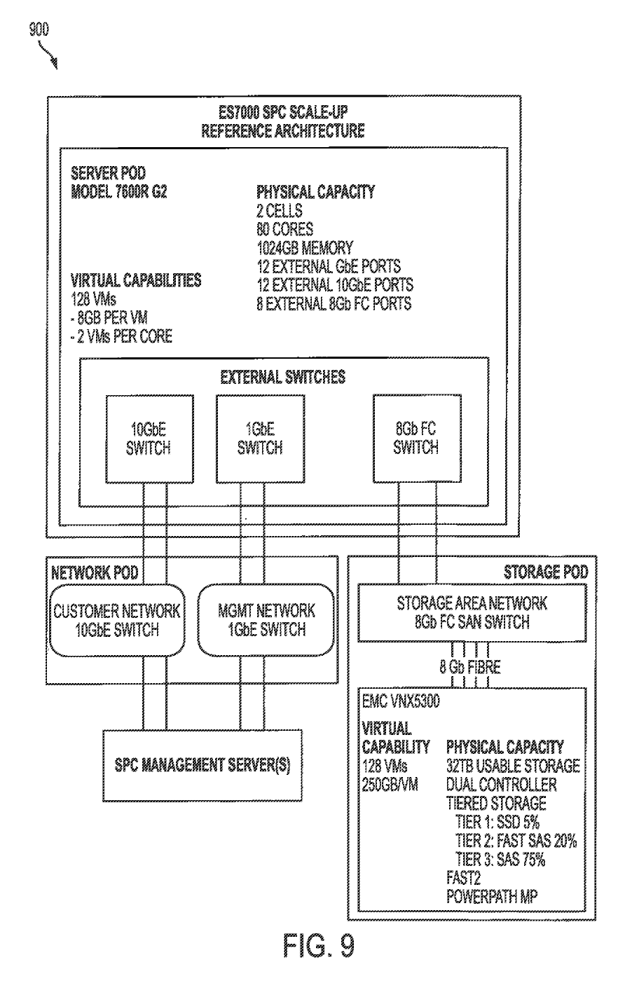

FIG. 9 illustrates an embodiment of an Enterprise Scalable (ESC) high availability POD configuration 900, which targets enterprise-class, scale-up workloads with high-availability requirements (e.g., scale up beyond 12 cores). The ESC POD configuration 900 is best fitted for the back office/database tier 136. For example, the ESC POD configuration 900 is well positioned with additional memory and I/O capacity to address a wider range of workloads and configurations from multiple VMs per core to multiple cores per VM to physical servers. However, in a virtualized environment, additional ESC PODs should be considered in the detailed implementation to address HA requirements.

In one embodiment, the ESC POD configuration 900 includes an eight-socket scalable server with a maximum capacity of 64 cores, 1 TB of memory and 40 TB of usable storage. For HA capability, additional components may be added including redundant SAN switches with load balancing, redundant networking (NIC teaming, redundant switch fabric) and premier operating system software and hypervisor. Clustering may be selected between the two 4-socket cells that make up the eight-socket server. Although the ESC POD configuration 900 does not explicitly address the management subsystem, a software management stack is required.

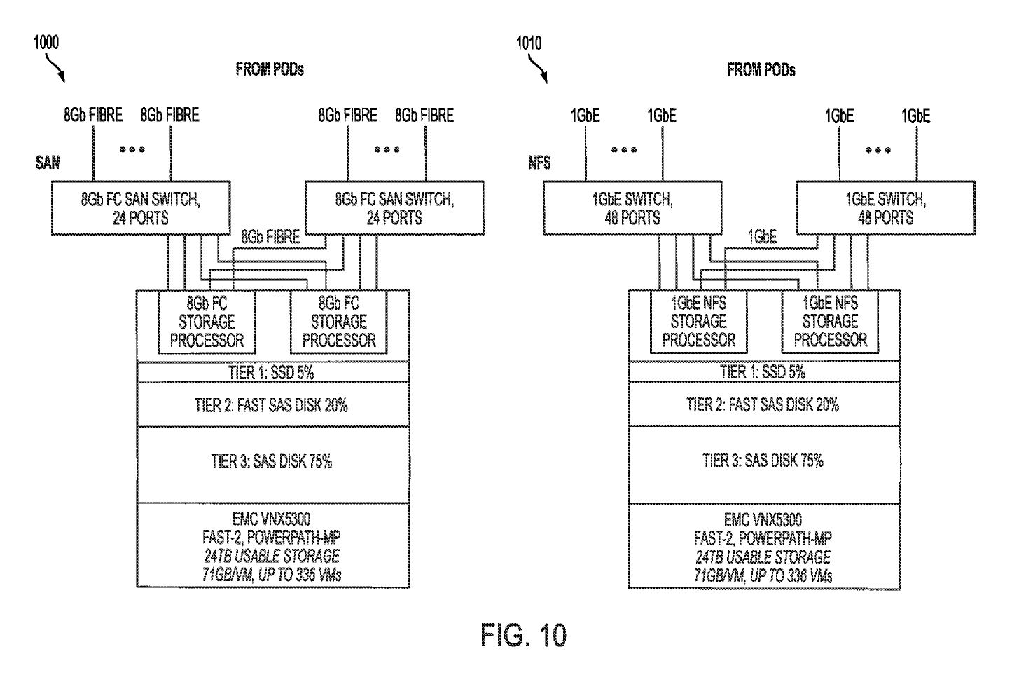

With reference now to embodiments of storage PODs, FIG. 10 illustrates examples of storage POD configurations in accordance with the disclosed embodiments. In particular, FIG. 10 illustrates the configuration of a SAN Storage POD 1000 and a Network File System (NFS) Storage POD 1010.

The disclosed storage PODs are designed to have enterprise-class performance, availability and protection features. The current building block for these PODs is the EMC VNX Model 5300 Unified Storage System, which is optimized for virtualized environments. Along with VNX, the Storage POD includes RecoverPoint software for business usage/disaster recovery (BU/DR) and Powerpath software for load balancing and failover.

The disclosed storage subsystem supports Enterprise Flash drives (EFDs), 15-rpm SAS disk drives and near-line 7200-rpm 1 TB or 2 TB SAS disks. These different types of disks are used by the FAST-VP tiered storage software for directing traffic to the right tiers for optimal performance.

The Small storage POD provides the storage capacity required by the Small Cloud RA blade or server PODs—70 GB per VM of tiered storage for up to 168 VMs. The Medium storage POD provides the storage capacity required by the Medium Cloud RA blade or server PODs—70 GB per VM of tiered storage for up to 336 VMs. The Large storage POD provides the storage capacity required by the Large Cloud RA blade POD—125 GB per VM of tiered storage for up to 336 VMs. The Enterprise Scale-Up (ESC) Storage POD provides the storage capacity required by the ESC RA—250 GB per VM of tiered storage for up to 128 VMs. Each of the storage PODs are independently configurable, with a range of capacities available. The capacities listed are the minimum suggested capacities, more drives can be added as required.

The default RAID configuration chosen for the storage PODs is RAID 5 arrays with 1 parity drive and a hot spare for each drive type (i.e. an EFD hot spare, a 15 k SAS hot spare and a 7200 rpm SAS hot spare).

The disclosed storage POD configurations provide a high level of fault tolerance and storage efficiency, which balances cost versus performance. Detailed sizing efforts and/or customer requirements influence the usable capacity (that is, other desired RAID levels) and must be considered in the final storage design implementation.

The server and storage reference configurations offer two different host connect options, FC (SAN) or NAS. The server RAs described in this document are the SAN option, with 8 Gb FC HBAs in the host system and the corresponding 8 Gb FC I/O modules in the VNX 5300 storage subsystem. For server and storage configurations where NAS storage is required, the VNX 5300 I/O modules will be configured for 1 Gb or 10 Gb modules depending on the desired speed and host I/O card option.

The disclosed storage POD configurations provide a high level of fault tolerance and storage efficiency, which balances cost versus performance. The capabilities of each configuration are stated in terms of the number of VMs supported and of the type of VMs (not all VMs are created equal). For example, a web tier VM might not be CPU or memory intensive (which allows for less memory/VM and more VMs/core) compared to a database VM. A database VM might require up to 4 GB of RAM per VM and have a limit of 2 VMs per CPU core, but a web tier VM can perform within an SLA with 2 GB of RAM per VM. The number and type of VMs that are optimal for a customer's environment are best determined with the workload analysis/migration and capacity planning tools. The analysis determines what type of server POD should be used for the VM profile, and what edge-connected components, as defined by customer requirements, are necessary to complete the infrastructure (for example, database accelerators, network and/or SAN load balancers, firewalls, and so on).

The I/O capacity of each server and storage POD is flexible enough to allow for a range of applications. However, the medium server POD is optimized for a web-tier environment with moderate-to-heavy network activity, where the I/O ratio is estimated to be around 65 percent network and 35 percent storage traffic. The large server and storage PODs are optimized for database usage with moderate-to-heavy storage activity, where the I/O ratio is estimated to be around 65 percent storage and 35 percent network traffic. The large number of network ports in each configuration (56 total) allows for virtualization hypervisors such as VMware with vMotion to use two ports for operating system and VM migration—leaving two ports per blade available for the customer network.

Accordingly, the disclosed embodiments provides an approach to deal with the uncertainties of the cloud-based workloads by suggesting a small number of profiles based on the current pattern of web, application and database tiers. The methodology supports an agile deployment model that is used early in the service delivery model and does not preclude the use of deeper forensics and analysis. Using reference configurations, as described above, to design private or hybrid cloud configurations shortens both the development/test and sales cycles plus ensures that the major building blocks necessary to build an enterprise-class cloud configuration have been considered. As the cloud expands, additional infrastructure can be quickly deployed so that it is balanced to handle the profiles without over-configuring in the areas of CPU, storage and networking resources.

The above embodiments are merely provided as examples and are not intended to limit the invention to any particular configuration.

Certain illustrative embodiments described herein can take the form of an entirely hardware embodiment, an entirely software embodiment or an embodiment containing both hardware and software elements. Furthermore, certain illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, or transport the program for use by or in connection with the instruction execution system, apparatus, or device. The previous detailed description discloses several embodiments for implementing the invention and is not intended to be limiting in scope. Those of ordinary skill in the art will recognize obvious variations to the embodiments disclosed above and the scope of such variations are intended to be covered by this disclosure. The following claims set forth the scope of the invention.

What is claimed is:

1. A system comprising:
a plurality of preconfigured hardware platforms that when combined is operable to reach maximum utilization of a computing request rate, a network request rate, and a storage request rate at approximately the same time.

2. The system of claim 1, wherein the plurality of preconfigured hardware platforms includes a server hardware platform selected from a set of preconfigured server hardware platforms, a network hardware platform selected from a set of preconfigured network hardware platforms, and a storage hardware platform selected set of preconfigured storage hardware platforms.

3. The system of claim 2, wherein the computing request rate, the network request rate, and the storage request is based on a workload profile associated with one of a plurality of tiers.

4. The system of claim 3, wherein the plurality of tiers consists of a web tier, an application tier, and a data tier such that the plurality of preconfigured hardware platforms is different depending on whether the workload profile of the system is associated with the web tier, the application tier, or the data tier.

5. The system of claim 4, wherein the workload profile is hardware independent.

6. The system of claim 4, wherein the server hardware platform, the network hardware platform, and the storage hardware platform are preconfigured for the same tier.

7. The system of claim 3, wherein the plurality of preconfigured hardware platforms is preconfigured with both hardware and software components associated with the one of the plurality of tiers.

8. The system of claim 3, wherein the workload profile is based on a number and a type of virtual machines associated with the web tier, the application tier, or the data tier.

9. A system comprising:
a server hardware platform;
a network hardware platform; and
a storage hardware platform,
wherein the server hardware platform, the network hardware platform, and the storage hardware platform are preconfigured based upon a workload profile for one of a plurality of tiers.

10. The system of claim 9, wherein the server hardware platform, the network hardware platform, and the storage hardware platform include both hardware and software components associated with the one of the plurality of tiers.

11. The system of claim 10, wherein the plurality of tiers comprises of a web tier, an application tier, and a data tier associated with a cloud service provider.

12. The system of claim 9, wherein the server hardware platform is selected from a set of server hardware platforms that includes at least one preconfigured server hardware platform based on a workload associated with a web tier, at least one preconfigured server hardware platform based on a workload associated with an application tier, and at least one preconfigured server hardware platform based on a workload associated with a data tier.

13. The system of claim 9, wherein the network hardware platform is selected from a set of preconfigured network hardware platforms that includes at least one preconfigured network hardware platform based on a workload associated with a web tier, at least one preconfigured network hardware platform based on a workload associated with an application tier, and at least one preconfigured network hardware platform based on a workload associated with a data tier.

14. The system of claim 9, wherein the preconfigured storage hardware platform is selected from set of preconfigured storage hardware platforms that includes at least one preconfigured storage hardware platform based on a workload associated with a web tier, at least one preconfigured storage hardware platform based on a workload associated with an application tier, and at least one preconfigured storage hardware platform based on a workload associated with a data tier.

15. The system of claim 9, wherein the server hardware platform, the network hardware platform, and the storage hardware platform when combined forms a combination that balances a computing request rate, a network request rate, and a storage request rate for one of a web tier, an application tier, and a data tier system.
